(19) United States
(12) Patent Application Publication
(10) Pub. No.: US 2020/0272117 A1
(43) Pub. Date: Aug. 27, 2020

(54) SYSTEMS FOR VEHICLES USING SIMPLIFIED STATE MACHINES

(71) Applicant: Byton North America Corporation, Santa Clara, CA (US)

(72) Inventor: Trampus Richmond, Santa Cruz, CA (US)

(21) Appl. No.: 16/283,339

(22) Filed: Feb. 22, 2019

(51) Int. Cl. G05B 19/042

(52) U.S. Cl. CPC G05B 19/042; G05B 2219/2637; G05B 2219/25257

(57) ABSTRACT

Systems for vehicles are disclosed using simplified state machines. For one example, a data processing system for a vehicle includes a plurality of subsystem nodes interconnected by a network topology. Each subsystem node includes a transceiver and micro-controller coupled to the transceiver. The micro-controller is configured to obtain an atomic machine state bit vector. Each bit of the atomic bit vector describes a state of the vehicle used by a state machine operating within the vehicle. The micro-controller multiplies a first bit vector mask with the atomic machine state bit vector to obtain a first result. The first result identifies first states of interest. The micro-controller determines a next state for the state machine based on the identified first states of interest. The micro-controller performs a function for the vehicle based on the determined next state. The atomic machine state bit vector can be updated based on the determined next state and distributed within the vehicle.

### FIELD

Embodiments of the invention are in the field of vehicles and data processing. More particularly, embodiments of the invention relate to systems for vehicles using simplified state machines.

### BACKGROUND

Vehicles such as electric or non-electric automobiles or sport utility vehicles (SUVs) can have any number of electronic control units (ECUs) to control specific functions for the vehicle such its motor, power steering, headlights, braking, etc. ECUs can be a micro-controller running firmware or code to perform its designated functions. In performing designation functions, ECUs can use state machines running in software the can receive inputs from any number of sensors and messages from other ECUs to determine a current state of the vehicle, e.g., brake lights on, motor on, battery charge low, etc., and if the vehicle changed from one state to another state. Within a vehicle, numerous states can be transmitted among any number of interconnected ECUs on busses to determine other states. Maintaining numerous states across multiple ECUs can thus become a difficult processing endeavor for multiple ECUs operating within a vehicle.

### SUMMARY

Systems for vehicles using simplified state machines are disclosed. For one example, a data processing system for a vehicle includes a plurality of subsystem nodes interconnected by a network topology. Each subsystem node includes a transceiver and micro-controller coupled to the transceiver. The micro-controller is configured to obtain an atomic machine state bit vector. Each bit of the atomic bit vector describes a state of the vehicle used by a state machine operating within the vehicle. The micro-controller multiplies a first bit vector mask with the atomic machine state bit vector to obtain a first result. The first result identifies first states of interest. The micro-controller determines a next state for the state machine based on the identified first states of interest. The micro-controller performs a function for the vehicle based on the determined next state. The atomic machine state bit vector can be updated based on the determined next state and distributed within the vehicle.

For one example, the data processing system updates the atomic machine state bit vector based on the determined next state. The updated atomic machine state bit vector is distributed within the vehicle. By using the atomic machine state bit vector, a simplified way of maintaining states throughout a vehicle can be maintained, updated and distributed among ECUs operating within a vehicle by a state machine in determining next states and performing functions for a vehicle.

For another example, the data processing system multiplies a second bit vector mask with the atomic machine state bit vector to obtain a second result. The second result identifies second states of interest. A next state for the state machine is determined based on the identified first and second states of interest. A function for the vehicle is performed based on the determined next state based on the identified first and second states of interest. For one example, determining the next state includes comparing the first states of interest with states identified for the next state in determining the next state. For another example, determining the next state based on the identified first and second states of interest includes comparing first states of interest or second states of interest in determining the next state.

Other systems, devices, apparatuses, methods and computer-readable mediums are described.

### BRIEF DESCRIPTION OF THE DRAWINGS

The appended drawings illustrate examples and are, therefore, exemplary embodiments and not considered to be limiting in scope.

FIG. 1A illustrate one example of a vehicle with interconnected electronic control units (ECUs) according to an exemplary network topology.

FIG. 1B illustrates one example of interconnected subsystem nodes according to a network topology of FIG. 1A to implement simplified state machines.

FIG. 2 illustrates one example of a simplified finite-state machine for the ECUs or subsystem nodes of FIG. 1A-B.

FIG. 3A illustrates one example of an atomic state bit vector of representing vehicle states for a simplified finite-state machine of FIG. 2.

FIG. 3B illustrates one example using a bit mask with the atomic state bit vector to obtain a result for determining a next state.

FIG. 3C illustrates one example one example of using first and second bit masks with the atomic state bit vector to obtain a result for determining a next state.

FIG. 4 illustrates one example block diagram of a comparator for the simplified state machine of FIGS. 2-3C to determine a next state.

FIG. 5 illustrates one example of a flow diagram of an operation for a finite-state machine.

FIG. 6 illustrates one example of a flow diagram of an operation for distributing an updated atomic machine state bit vector.

### DETAILED DESCRIPTON

Systems for vehicles are disclosed for using simplified state machines. For one example, a vehicle includes any number of electronic control units (ECUs) that performs a function of the vehicle based on one more states of the vehicle using a state machine. The state machine for the ECUs can use an atomic machine state bit vector comprising a plurality of bits, and each bit can describe a state within a vehicle. The atomic machine state bit vector can provide a simplified way of maintaining states throughout a vehicle, which can be maintained by updating and distributing the atomic machine state bit vector based on changing states within the vehicle. For one example, bit vector masks can be used to multiply with the atomic machine state bit vector to obtain states of interest. The states of interest can be compared to states for a next state. If the next state is determined based on the states of interest, the state machine for one or more ECUs can perform a function for the vehicle based on the next state.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described in order to provide a concise discussion of the embodiments and examples. Although the following examples and embodiments are directed to vehicles including electric or non-electric automobiles or sports utility vehicles (SUVs), the disclosed techniques can be applied to any type of environment using a data processing system with finite-state machines.

### Exemplary Vehicle with Interconnected ECUs and Subsystem Nodes

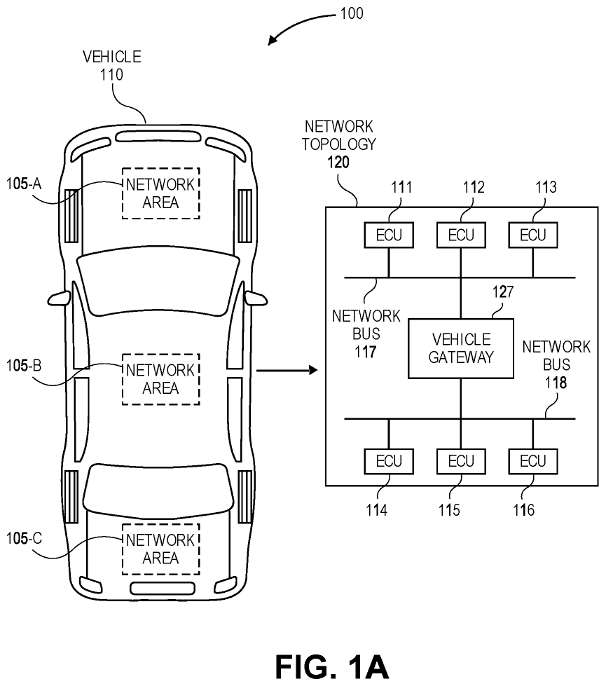

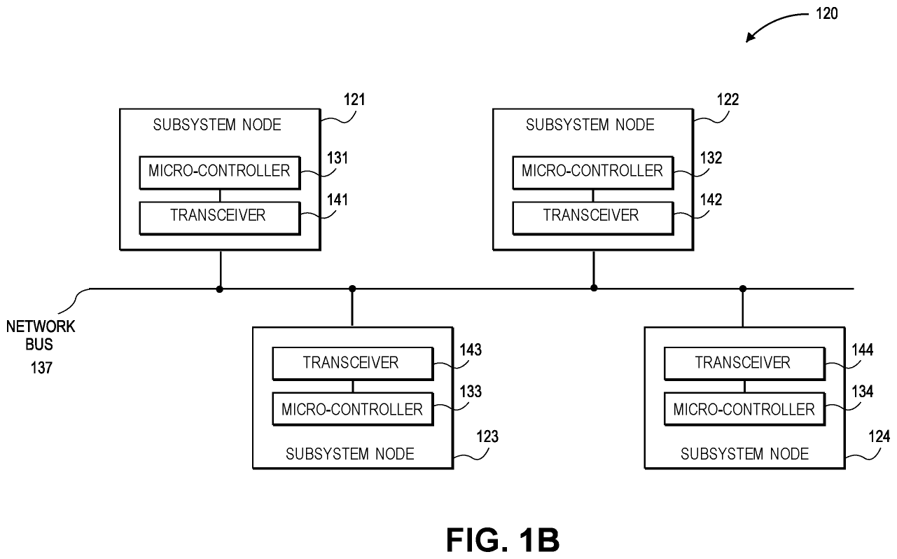

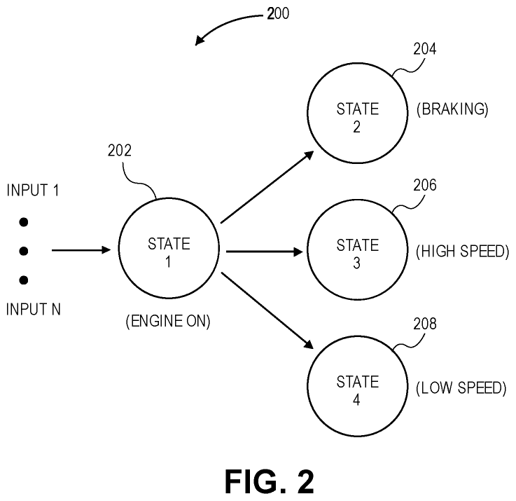

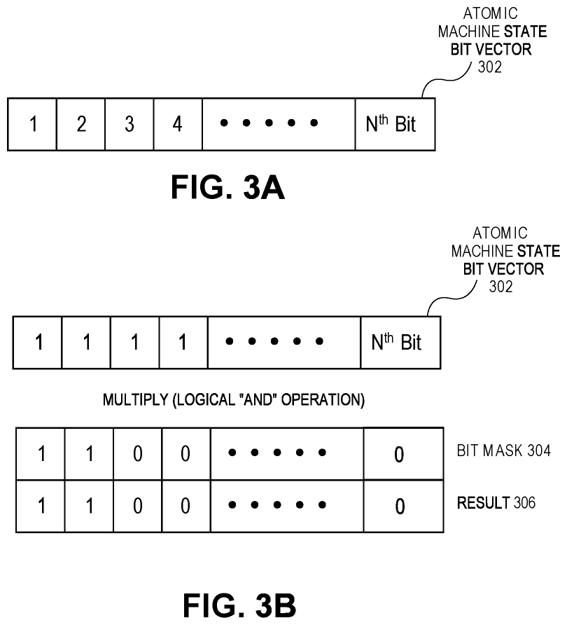

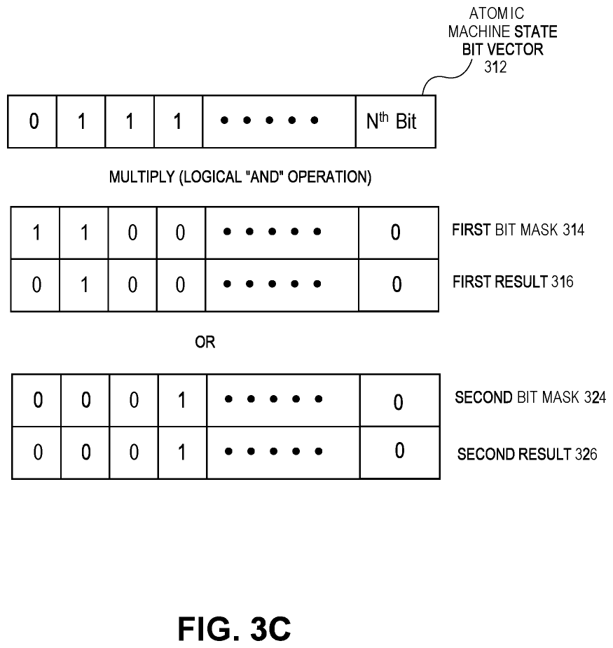

FIG. 1A illustrate one example of a top view 100 of a vehicle 110 having a network topology 120 of interconnected electronic control units (ECUs) 111-116. ECUs 111-116 can be a micro-controller, computing or data processing system, system-on-chip (SOS), or any embedded system that can run firmware or program code to perform individual functions and control of various components within vehicle 110 including running a finite-state machine as disclosed herein. Vehicle 110 can include any number of network areas including network areas 105-A through 105-C located throughout vehicle 110. Each network area 105-A to 105-C can include any number ECUs interconnected by way of network topology 120 with network busses 117 and 118. Each ECU can run firmware or program code to perform its function and control any number of electronic components operating within vehicle 110. For one example, ECUs 111-116 can implement a simplified finite-state machine 200, as disclosed in FIG. 2, in which states for vehicle 110 can be represented globally within vehicle 110 by an atomic machine state bit vector 312 as shown in FIG. 3A. By using atomic machine state bit vector 312, a simplified manner of maintaining states and determining next states across finite-state machines for ECUs operating within a vehicle can be achieved.

Referring to FIG. 1A, ECUs in the front end of vehicle 110, such as network area 105-A, can have ECUs controlling electronic components for headlights, power steering, braking, engine controls etc. Network area 105-B in the mid-section of vehicle 110 can have ECUs controlling electronic components for opening and closing door locks and other interior controls. Network area 105-C near the back end of vehicle 110 can have ECUs controlling electronic components for tail lights, battery, trunk and other electronic components. In performing their designated functions, ECUs 111-116 can implement finite-state machines using atomic machine state bit vectors and masks to determine whether to stay in a current state or transition to another state using techniques described in FIGS. 2-6. For one example, an ECU can transmit messages including a changed state, e.g., brake lights on, to another ECU or a vehicle gateway (e.g., vehicle gateway 127) in which the ECU or gateway receiving the message can update its atomic machine state bit vector describing the global states of vehicle 110.

For one example, network topology 120 includes network or communication busses 117 and 118 interconnecting ECUs 151 through 156 and coupling the ECUs to vehicle gateway 127. In this way, network topology 120 allows ECUs and vehicle gateway 127 in different networking areas of vehicle 110 to communicate messages and signals with each other. For one example, vehicle gateway 127 can be a micro-controller, computing or data processing system, system-on-chip (SOS), or any embedded system that can run firmware or software code to perform individual functions and control of various components within vehicle 110 including running a finite-state machine as disclosed herein.

For one example, network topology 120 and busses 117 and 119 can support any number of messaging networks and protocols including Controller Area Network (CAN), Local Interconnect Protocol (LIN), and Ethernet network and protocol. For one example, the messaging protocols can define messages using network descriptor files, e.g., CAN database container (DBC) files, LIN network descriptor files (LDF) and Ethernet network descriptor files, which describe the network topology, ECUs connected to a bus, and the messages and signals used by the ECUs. In other words, network descriptor files can provide a map of ECUs for network topology 150. For some examples, ECUs for network area 105-A can have its own network descriptor file as well as ECUs for network areas 105-B and 105-C, respectively. In other examples, each ECU can have its own network descriptor file. Each ECU can run firmware or code based on message and signal definitions in respective network descriptor files.

For one example, vehicle gateway 127 can coordinate communication within network topology 120 between the ECUs 111-116. For one example, vehicle gateway 127 interconnects groups (or networks) and can coordinate communication between a group of ECUs 111-113 with another group of ECUs 114-116 on busses 117 and 118. Vehicle gateway 127 can also have a wireless network connection to connect externally to the cloud or Internet and communicate external signals and data, e.g., global positioning system (GPS) signals and data.

FIG. 1B illustrates one exemplary block diagram of network topology 120 of FIG. 1A having a plurality of interconnected subsystem nodes 121-124 on network bus 137. The subsystem nodes 121-124 can represent ECUs 111-116 or vehicle gateway 127 in FIG. 1A and operate in the same way using micro-controllers 131-134 and transceivers 141-144. Although four subsystem nodes are shown, any number of subsystem nodes can be implemented for network topology 120 of vehicle 110. Each of the subsystem nodes 121-124 are coupled to network bus 137, which can support any type of vehicle network, e.g., a CAN, LIN or Ethernet network. For example, transceivers 141-144 can support data messaging according to the ISO 11898-1, ISO/AWI 17987-8 and IEEE 802.11 protocols. Micro-controllers 131-134 can control vehicle components, functions or services and communicate with other subsystem nodes including implement simplified state machines as disclosed herein. For other examples, network bus 137 is coupled to a vehicle gateway 127 and subsystem nodes 121-124 are coupled to vehicle gateway 127 or, alternatively, a subsystem node can be a vehicle gateway 127. The micro-controllers 131-134 can run firmware or code according to the atomic machine state bit vector 312 as described in FIG. 3A.

### Exemplary Simplified State Machine Operation

FIG. 2 illustrates one example of a simplified finite-state machine 200 for the ECUs or subsystem nodes of FIG. 1A-1B. For one example, finite-state machine 200 can be a mathematical or computation model implemented in firmware, software, or program code running on each of ECUs 111-116 or vehicle gateway 127 or subsystem nodes 121-124. Referring to FIG. 2, finite-state machine 200 has a list of states, e.g., state 1 (202) through state 4 (208). Finite-state machine 200 can operate with any number of states. Each state can represent a state of vehicle 110. For example, state 1 (202) can refer to vehicle 110 having its “Engine On,” state 2 (204) can refer to vehicle 110 is “Braking,” state 3 (206) can refer to vehicle 110 is operating at “High Speed,” and state 4 (208) can refer to vehicle 110 operating at “Low Speed.” These states are exemplary for discussion purposes and any number of states and types of states can be used for finite-state machine 200. In addition, any ECU, gateway or subsystem nodes for vehicle 110 can implement finite-state machine 200 operating within vehicle 110.

For one example, an ECU or subsystem node for a motor can implement finite-state machine 200 that can enter state 1 (202)—“Engine On.” At state 1 (202), finite-state machine 200 can receive any number of inputs, e.g., inputs 1 through N. Each input 1-N can be another state or signal and used to determine a next state, e.g., states 2-4. For example, at state 1 (202), finite-state machine 200 can receive inputs as states such as, e.g., “rear brake lights on” which is provided from a rear brake ECU or subsystem node and “low motor speed” which can be a signal or state from a sensor indicating low speed. Such states, e.g., “rear brake lights on” and “low motor speed” can be represented by a respective bit in atomic machine state bit vector 302 as shown in FIG. 3A. For example, bit 1 and bit 2 of atomic machine state bit vector 302 can be designated for the states “rear brake lights on” and “low motor speed.” Atomic machine state bit vector 302 can represent the global states for vehicle 110.

For one example, in determining a next state from state 1 (202), finite-state machine 200 can use a bit mask 304 as shown in FIG. 3B which can mask out other bits except for the bits related to “rear brake lights on” and “low motor speed” or bits 1 and 2 of the atomic machine state bit vector 302 which provides a result 306 having bits 1 and 2 with a “1.”

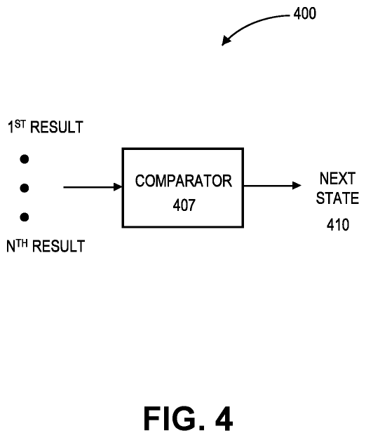

For one example, the result 306 (or other results) can be input to a comparator 407 as shown in FIG. 4 to determine the next state. For example, comparator 407 can be configured to determine that if bits 1 and 2 are “1” then vehicle 110 is in state 4 (208) low speed. That is, if vehicle 110 has rear brake lights on and low motor speed, state 4—Low Speed—is determined for vehicle 110. This new state can be updated in the atomic machine bit vector 302 and distributed to the ECUs and gateway within network topology 150. Additional details of operation of the simplified finite-state machine 200 are provided below.

### Exemplary Atomic Machine State Bit Vector, Masks and Results

FIG. 3A illustrates one example of an atomic state bit vector 302 of representing vehicle states for a simplified finite-state machine 200 of FIG. 2. In this example, atomic state bit vector 302 includes a plurality of bits 1 through the N bits. For one example, atomic state bit vector 302 can be stored in a register or be one or more words stored in memory. Each bit of atomic state bit vector 302 can represent a state of a vehicle. For example, four bits in vector 302 can be designated for the states such as, e.g., “Engine On,” “Braking,” “High Speed,” “Low Speed” etc. Atomic state bit vector 302 can have any number of bits to represent any number of states for vehicle 110. Each bit can be controlled or maintained by one or more ECUs. For example, an ECU for the controlling the engine may maintain one or more bits of the atomic state bit vector 302 for “Engine On,” “Braking,” “High Speed,” and “Low Speed.” Atomic bit vector 302 can be updated by one or more ECUs and distributed within network topology 150 to other ECUs 151-156 or gateway 157 as illustrated in FIG. 1. For example, messages or packets can be transmitted within network topology 150 including atomic state bit vector 302.

FIG. 3B illustrates one example using a bit mask 304 with the atomic state bit vector 302 to obtain an inclusive result 306 for determining a next state. In this example, the first our bits of the atomic machine state vector 302 includes a bit value of “1”. And in determining a next state by a finite-state machine, e.g., finite state machine 200, only the first two bits can be of interest. Thus, bit mask 304 can be used that includes bit values of “1” in the first two bits and all other bit values are given a value of “0.” Bit mask 304 can then be multiplied or a Boolean AND operation can be performed with atomic machine state bit vector 302 which has the first four bits with a value of “1.” In this way, bit mask 304 masks the 3^{rd} bit to the N^{th} bit to determine values for bits of interest which are the first two bits of the atomic machine state bit vector 302, which can provide a result 306 giving a bit value “1” for bits 1 and 2. For example, if bits 1 and 2 are designated for “Engine On” and “Braking” then result 306 identifies bits of interest for bits 1 and 2 indicating states such as “Engine On” and “Braking”. For one example, referring to FIG. 4, result 306 can be an inclusive result which can be a sole input to comparator 407. That is, result 306 can be the input to comparator 407 with values “1” and “1” indicating if that the first two states are true, e.g., “Engine On” and “Braking.” Comparator 407 can then determine a next state 410 based on these inputs and compare them to states indicating the next state. For example, comparator 407 may determine that the next state 410 is “High Speed” if the states are true for the first two bits indicating, e.g., “Engine On” and “Braking.”

FIG. 3C illustrates one example one example of using first and second bit masks 314 and 324 with the atomic state bit vector to obtain first and second results 316 and 326 for determining a next state. In this example, the first our bits of the atomic machine state vector 302 includes bit values of “0 1 1 1”. For one example, first bit mask 314 has the first two bits with values of “1” indicating bits of interest and all the other bits (3^{rd} to N^{th} bit) are masked having a value of “0”. First bit mask 314 can be multiplied (or a Boolean AND operation performed) with atomic machine state bit vector 312 providing the first result 316. That is, referring to first four bits, the atomic machine state bit vector 312 values of “0 1 1 1” are multiplied or AND with “1 1 0 0” with first bit mask 314 providing first result of 316 having values “0 1 0 0”. In this example, only the second bit has a value of “1” indicating its state is true, e.g., vehicle 110 is “Braking.” First result 316 can be an input to comparator 407 in FIG. 4 which can be used to determine a next state 410 for a finite-state machine 200.

For another example, second bit mask 324 having bit values for the first four bits as “0 0 0 1” and all other bits “0”. In this example, second bit mask 324 masked all bits except for the fourth bit which is set with a value “1”. Second bit mask 324 can be multiplied with atomic machine state bit vector 312 having values “0 1 1 1” for its first four bits and all other bits having a value of “0”. In this multiplication, second result 326 can be obtained that provides a result of “0 0 0 1” for the first four bits. For one example, finite state machine 200 can use either first result 316 OR second result 326 which can be inputs comparator 407 in FIG. 4 to obtain a next state 410 for a finite-state machine 200. That is, in this example, based on first bit mask 314 the first two bits or states are of interest or the fourth bit or state is of interest based on the second bit mask 326. For one example, comparator 407 can determine next state 410 if the states for the first two bits are trued or if the state for the fourth bit is true. Next state 410 can require one or more bits of the atomic machine state bit vector 312 to be updated with bits asserted if a state is true, e.g., if vehicle 110 enters into “Low Speed.” State-machine 200 for any of the ECUs 111-116, vehicle gateway 127 or subsystem nodes 121-124 can forward or distribute an updated atomic machine state bit vector 312 or 302 to other ECUs, subsystem nodes, vehicle gateway or other components within vehicle 110.

### Exemplary Simplified State Machine Operations

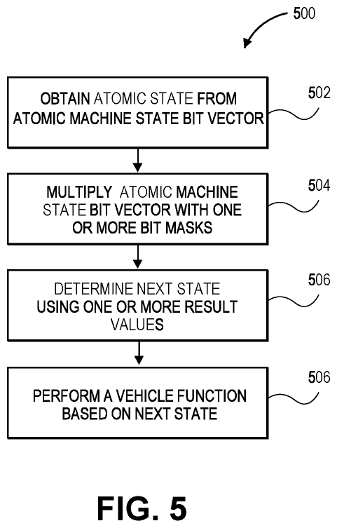

FIG. 5 illustrates one example of a flow diagram of an operation 500 for a finite-state machine (e.g., finite-state machine 200). Operation 500 includes operations 502 through 508.

At operation 502, an atomic state of an atomic machine state bit vector (e.g., atomic machine state bit vector 302 or 312) is obtained. The atomic machine state bit vector can include a plurality of bits, where each bit can represent a state of a vehicle, and be obtained from a register or from one or more words in memory.

At operation 504, one or more bit masks are multiplied with the obtained atomic machine state bit vector. The bit masks can mask bits or states of interest within an atomic machine state bit vector. The multiplication or Boolean AND operation can produce one or more results that identified states of interest as illustrated in FIGS. 3A-3C.

At operation 506, a next state can be determined using one or more result values based on the multiplication of the bit masks with the atomic machine state bit vector. For example, referring to FIG. 4, one or more results from the multiplication can be input to a comparator 407 which determines whether states for a next state match states of interest input to comparator 407 to determine a next state 410.

At operation 508, a vehicle function can be performed based on the next state. For example, a finite-state machine (e.g., finite-state machine 200) can be implemented by one or more ECUs operating within a vehicle (e.g., vehicle 110). The finite-state machine can determine a next state which is used by one or more ECUs to perform a function for the vehicle, e.g., turn on regenerative breaking or turn on headlights etc.

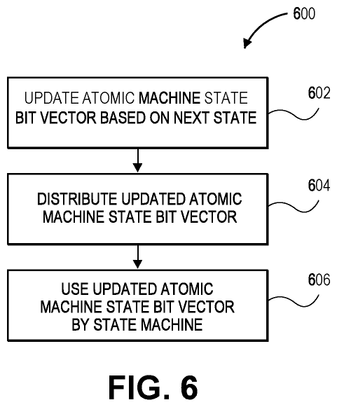

FIG. 6 illustrates one example of a flow diagram of an operation 600 for distributing an updated atomic machine state bit vector (e.g., atomic machine state bit vector 302 or 312). Operation 600 includes operations 602 through 606.

At operation 602, an atomic machine state bit vector (e.g., atomic machine state bit vector 302 or 312) is updated based on a next state (e.g., next state 410). For one example, once a next state is determined a new state can be determined and atomic machine state bit vector updated to reflect the new state.

At operation 604, the updated atomic machine state bit vector can be distributed within a vehicle (e.g., vehicle 110). For example, one or more ECUs, subsystem nodes or vehicle gateway running a state machine can distribute the updated atomic machine state bit vector to other ECUs or a gateway. In one example, a next state can be distributed and each ECU can update respective atomic machine state bit vectors to reflect the updated state.

At operation 606, the updated atomic machine state bit vector is used by a state machine to determine a next state and to perform a vehicle function based on the next state. The updated atomic machine state bit vector can be used by any ECU, subsystem node or gateway operating within a vehicle.

In the foregoing specification, the invention has been described with reference to specific exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

1. A data processing system for a vehicle comprising:
a plurality of subsystem nodes interconnected by a network topology, each subsystem node including a transceiver and micro-controller coupled to the transceiver and the micro-controller configured to
obtain an atomic machine state bit vector via the transceiver, each bit of the atomic machine state a bit vector describing a state of the vehicle used by a state machine operating within a subsystem node,
multiply a first bit vector mask with the atomic machine state bit vector to obtain a first result, the first result identifying first states of interest,
determine a next state based on the identified first states of interest, and
perform a function for the vehicle based on the determined next state.

2. The data processing system of claim 1, wherein the micro-controller is configured to
multiply a second bit vector mask with the atomic machine state bit vector to obtain a second result, the second result identifying second states of interest,
determine a next state based on the identified first and second states of interest, and
perform a function for the vehicle based on the determined next state based on the identified first and second states of interest.

3. The data processing system of claim 1, wherein the micro-controller is configured to determine the next state by comparing the first states of interest with states identified for a next state.

4. The data processing system of claim 2, wherein the micro-controller is configured to determine the next state based on the identified first and second states of interest by comparing first states of interest or second states of interest with states identified for a next state.

5. The data processing system of claim 1, further wherein the micro-controller is configured to
update the atomic machine state bit vector based on the determined next state, and
distribute the updated atomic machine state bit vector within the vehicle.

6. A non-transitory computer-readable medium, including instructions which if executed by a data processing system, causes the data processing system to perform an operation comprising:
obtaining an atomic machine state bit vector, each bit of the atomic machine state bit vector describing a state of the vehicle used by a state machine operating within the vehicle;
multiplying a first bit vector mask with the atomic machine state bit vector to obtain a first result, the first result identifying first states of interest;
determining a next state for the state machine based on the identified first states of interest; and
performing a function for the vehicle based on the determined next state.

7. The non-transitory computer-readable medium of claim 6, wherein the data processing system performs an operation comprising:
multiplying a second bit vector mask with the atomic machine state bit vector to obtain a second result, the second result identifying second states of interest;
determining a next for the state machine based on the identified first and second states of interest; and
performing a function for the vehicle based on the determined next state based on the identified first and second states of interest.

8. The non-transitory computer-readable medium of claim 6, wherein the data processing system performs an operation comprising comparing the first states of interest with states identified for the next state in determining the next state.

9. The non-transitory computer-readable medium of claim 6, wherein the data processing system performs an operation comprising comparing first states of interest or second states of interest in determining the next state.

10. The non-transitory computer-readable medium of claim 6, wherein the data processing system performs an operation comprising:
updating the atomic machine state bit vector based on the determined next state; and
distributing the updated atomic machine state bit vector within the vehicle.

11. A vehicle comprising:
a plurality of electronic control units (ECU), each ECU implementing a state machine to perform a function for the vehicle, wherein the state machine is configured to:
obtain an atomic machine state bit vector, each bit of the atomic bit vector describing a state of the vehicle,
multiply a first bit vector mask with the atomic machine state bit vector to obtain a first result, the first result identifying first states of interest,
determine a next state based on the identified first states of interest, and
perform a function for the vehicle based on the determined next state.

12. The vehicle of claim 11, wherein the state machine is further configured to:
multiply a second bit vector mask with the atomic machine state bit vector to obtain a second result, the second result identifying second states of interest,
determine a next based on the identified first and second states of interest, and
perform a function for the vehicle based on the determined next state based on the identified first and second states of interest.

13. The vehicle of claim 11, wherein the state machine is further configured to compare the first states of interest with states identified for the next state in determining the next state.

14. The vehicle of claim 12, wherein the state machine is further configured to comparing first states of interest or second states of interest in determining the next state.

15. The vehicle of claim 11, wherein the state machine is further configured to:
update the atomic machine state bit vector based on the determined next state, and
distribute the updated atomic machine state bit vector within the vehicle.

16. A method for a vehicle comprising:
obtaining atomic machine state bit vector, wherein each bit of the atomic machine state bit vector describes a state of the vehicle used by a state machine operating within the vehicle;
multiplying a first bit vector mask with the atomic bit vector to obtain a first result, the first result identifying first states of interest;
determining a next state based on the identified first states of interest; and
performing a function for the vehicle based on the determined next state.

17. The method of claim 16, further comprising:
multiplying a second bit vector mask with the atomic bit vector to obtain a second result, the second result identifying second states of interest;
determining a next state based on the identified first and second states of interest; and
performing a function for the vehicle based on the determined next state based on the identified first and second states of interest.

18. The method of claim 16, further comprising:
comparing the first states of interest with states identified for a next state.

19. The method of claim 17, further comprising:
comparing first states of interest or second states of interest with states identified for a next state.

20. The computing method of claim 16, further comprising:
updating the atomic bit vector based on the determined next state; and
distributing the updated atomic bit vector within the vehicle.
